(19) United States
(12) Patent Application Publication
(10) Pub. No.: US 2010/0158202 A1
(43) Pub. Date: Jun. 24, 2010

(54) Location Based Emergency Services Dispatching

(75) Inventors: Randy Scott Johnson, O Fallon, MO (US); Tedrick Neal Northway, Wood River, IL (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/342,962

(22) Filed: Dec. 23, 2008

(51) Int. Cl. H04M 11/04

(52) U.S. Cl. 379/45

(57) ABSTRACT

An embodiment of the invention provides a method for dispatching emergency responders. The method identifies emergency responders proximate an emergency incident site. Of these emergency responders, qualified emergency responders are identified, wherein qualified emergency responders have sufficient resources to service an emergency incident at the emergency incident site. The method identifies travel obstructions between the qualified emergency responders and the emergency incident site. Travel times between each of the qualified emergency responders and the emergency incident site are determined based on the travel obstructions. A first emergency responder is selected from the qualified emergency responders, wherein the first emergency responder has a first travel time that is the shortest travel time of the determined travel times. One or more standby emergency responders are also selected, wherein the standby emergency responders have a second travel time that is the next shortest travel time of the determined travel times.

### I. FIELD OF THE INVENTION

The present invention is in the field of methods, computer program products, and tools for location based emergency services dispatching.

### II. BACKGROUND OF THE INVENTION

As population density increases, it has become more challenging for emergency responders (e.g., police, paramedics, firefighters) to respond and arrive at the site of an emergency incident in a timely manner. For example, once an alarm is received by firefighters, delays may be experienced due to traffic, weather, and availability of equipment and other resources.

In smaller communities, once a call for assistance is received by the dispatcher, the dispatcher notifies the city's emergency team to respond. Generally, in smaller communities, there are mutual aid agreements with nearby communities whose emergency responders are also made aware of the incident. The emergency responders of the nearby communities standby if their resources are needed to support the emergency incident. In larger cities, calls for assistance are received by dispatchers, who deploy the emergency responder that is closest to the caller's location according to a map. Other emergency responders within the city are also made aware of the incident and go on standby in the event they are needed as support.

Delays in reaching the site of the emergency may occur as a result of, for example, growth of the community, increased volume of traffic at busy intersections, and road congestion. Delays may also be caused by vehicle accidents that occur in the route that the emergency responder is using to travel to the site. In addition, the dispatcher often assumes that there is enough capacity available from the emergency responder to service the incident. Emergency responders may later discover that capacity is not available and time is lost dispatching a backup (standby) emergency responder.

### III. SUMMARY OF THE INVENTION

An embodiment of the invention provides a method for dispatching emergency responders to an emergency incident site. The method receives a request to dispatch an emergency responder to an emergency incident site and identifies emergency responders proximate the emergency incident site. Of these emergency responders, qualified emergency responders are identified from a database, wherein qualified emergency responders have sufficient resources to service an emergency incident at the emergency incident site.

The method identifies travel obstructions between the qualified emergency responders and the emergency incident site. The travel obstructions include traffic congestion, road construction, and traffic accidents. Travel times between each of the qualified emergency responders and the emergency incident site are determined based on the travel obstructions. Based on the determined travel times, a first emergency responder is selected from the qualified emergency responders. The first emergency responder has a first travel time that is the shortest travel time of the determined travel times. One or more standby emergency responders are also selected from the qualified emergency responders based on the determined travel times. The standby emergency responders have a second travel time that is the next shortest travel time of the determined travel times.

The first emergency responder is dispatched to the emergency incident site; and, the database is updated to indicate that the first emergency responder is unavailable. If a delay is encountered by the first emergency responder, a recalculated first travel time is determined by recalculating the first travel time. The standby emergency responder is dispatched if the second travel time is less than the recalculated first travel time; and, the database is updated to indicate that the second emergency responder is unavailable.

### IV. BRIEF DESCRIPTION OF THE DRAWINGS

The present invention is described with reference to the accompanying drawings. In the drawings, like reference numbers indicate identical or functionally similar elements.

FIG. 1 is a diagram illustrating conditions that may occur that prevent emergency responders from arriving at the incident site in a timely manner;

FIG. 2 is a diagram illustrating a method for location based emergency services dispatching according to one embodiment of the invention;

FIG. 3 is a diagram illustrating a method for location based emergency services dispatching according to another embodiment of the invention; and

FIG. 4 is a diagram illustrating a representative hardware environment for practicing an embodiment of the invention.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a tool for determining the best emergency responder to dispatch to an emergency location based upon available capacity and any travel issues between the emergency responders and the emergency location. If a travel issue occurs after the emergency responder has been dispatched, the next best emergency responders can also be dispatched.

At least one embodiment of the invention provides an automated tool that utilizes a number of variables to determine the optimal emergency responder to dispatch to the emergency service request. The tool maps the location and triangulates with emergency responders in the area. For each emergency responder, the tool determines if the emergency responder has available capacity and capability to respond to the incident. From that pool of emergency responders, the tool identifies any issues with the travel route between the emergency responders to the incident site. These issues may include traffic conditions such as traffic congestion due to rush hour, road repair work, and accidents. Route mapping is performed for each emergency responder taking these issues into account to determine the estimated travel time for each emergency responder. The emergency responder best able to respond is then dispatched and standby resources are notified. If any travel issues occur along the route, the tool estimates the new travel time for that emergency responder. If the data suggests that one of the alternate emergency responders is more viable and can respond faster, then dispatch is made to the optimum alternate emergency responder and the original emergency responder is recalled.

Typically, emergency responders receive the alert and reference street maps to assist the emergency responder in reaching the incident site. The emergency responders may use onboard GPS systems to define and select the route where street construction or traffic issues may be displayed. However, by the time that the traffic obstruction is realized, it may be too late to ensure that the best emergency responder was dispatched.

Each emergency responder has access to a centralized database where the availability of personnel and equipment is maintained. Updates are made to the database due to schedules, equipment repairs, and additional capacity (e.g., new equipment). As emergency responders are dispatched, the personnel and equipment are automatically marked ‘In Use’ as part of the dispatch process. The emergency responders are returned to ‘Available’ when the incident is over.

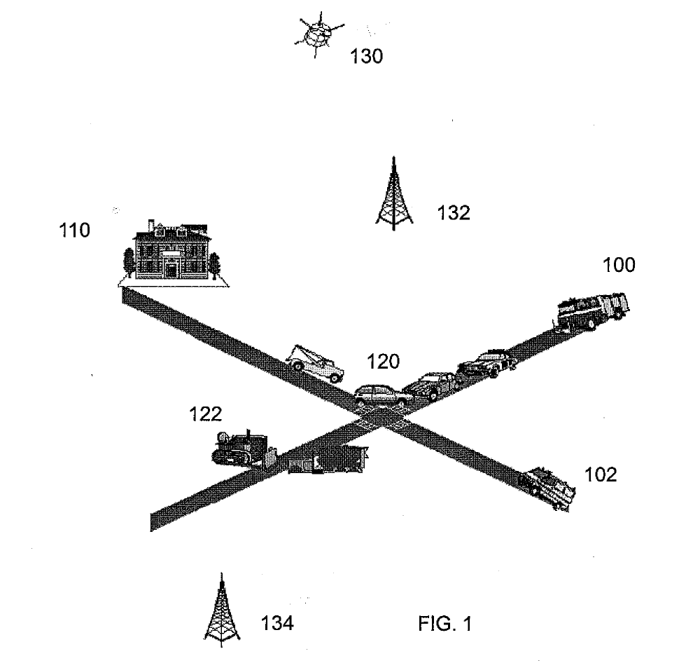

FIG. 1 illustrates conditions that may occur that prevent emergency responders 100 and 102 from arriving at an emergency incident site 110 in a timely manner. Such conditions include, for example, vehicle accidents 120 and road construction 122. The tool gathers data from existing resources. This includes, for example, GPS data from a satellite 130 and traffic data from cellular telephone towers 132, 134. The GPS data is utilized to map routes and track the location of emergency responders. As described more fully below, data from the cellular telephone towers 132 is captured to identify areas of traffic congestion.

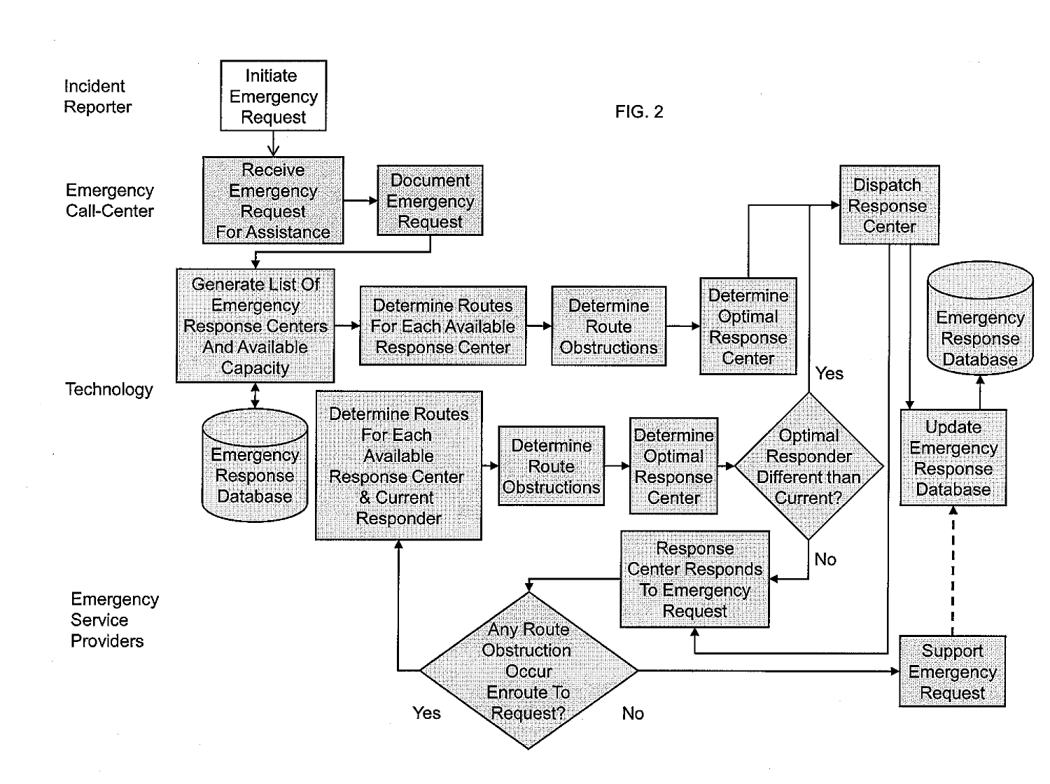

FIG. 2 is a flow diagram illustrating a method of selecting an emergency responder according to an embodiment of the invention that is initiated by the actual party impacted, a witness, or an automated system places an emergency call for assistance (100). The Emergency Call Center receives the call and gathers the required data about the incident, including the location of the emergency incident (200). The incident coordinates may be obtained based on address information for the telephone number or cellular telephone location provided data such as from GPS or cell tower triangulation. The agent at the Emergency Call Center documents the request data into the tool (210). For example, the data in at least one embodiment includes: the type of incident (e.g., fire, burglary, medical, or combination thereof), the location of the incident (e.g., obtained from location tracking of a telephone call), and the emergency response requirements (e.g., medical treatment requirements, the fire is chemical based) needed for determination of the request response.

The tool utilizes the emergency response database to generate a list of all emergency responders in the area and their available capacity (300). Further, the tool determines the estimated travel time using the most efficient route to the incident for each of the emergency responders (310). Specifically, for each of the emergency responders, the tool uses one or more electronic maps to produce potential routes of travel between the emergency responder and the emergency site. For each potential route, the tool produces an estimated travel time based on the distance and speed limit(s) along the route. In at least one embodiment, other factors in estimating the travel time include the number of traffic lanes available, the number of traffic lights that can be controlled by emergency vehicles, and estimated speed of travel of the emergency vehicle regardless of speed limit(s) along the route.

Location based services are utilized to identify route obstructions from each emergency responder location to the incident location and to calculate their impact on the travel time (320). In other words, for each route identified in 310, the tool identifies obstruction(s) along the route and estimates a delay time for each obstruction. The delay times are then added to the original travel time estimates to produce new travel time estimates that take into account the route obstructions. Examples of route obstructions include road construction, accidents, weather impacts, and traffic congestion (e.g., rush hour or sporting event). Route obstruction information may be obtained, for example, via transportation websites, radio, social networks, GPS data, data from cellular telephone towers. In at least one embodiment of the invention, the following calculation is performed for each emergency responder: Response Time=Travel Time+Road Construction delta+Accident delta+Weather delta+Traffic delta (330).

The optimal primary emergency responder has the capacity required and the shortest travel time. The emergency responder with the capacity required and the next shortest travel time is the secondary emergency responder. Based on the severity of the emergency service request or other emergency requests in progress, a single responder may not have sufficient capacity to support the request. In that case, the optimal primary emergency responders combine to have the capacity required and the shortest combined response time. In other words, in identifying emergency responders having sufficient resources to service an emergency incident, the tool can identify two or more emergency responders proximate the emergency site that individually do not have sufficient resources, but in combination have sufficient resources to service the emergency incident.

The tool dispatches the optimal emergency responder(s) to the incident and advises the secondary emergency responder to standby in case they are needed (340). The selected emergency responder is dispatched to the emergency site (220); and, the personnel and equipment utilized are marked ‘In Use’ in the emergency response center database (345). If any route obstructions occur while the emergency responder is in route to the incident location (230) the tool recalculates the optimal responder (310-330) and if different from the current responder, dispatches the new optimal responder and recalls the current responder (340). If a route obstruction is not present, the tool proceeds to support the emergency request. Specifically, the emergency responder supports the emergency request and returns when complete (240); and, the personnel and equipment utilized are marked ‘Available’ in the emergency response center database (346).

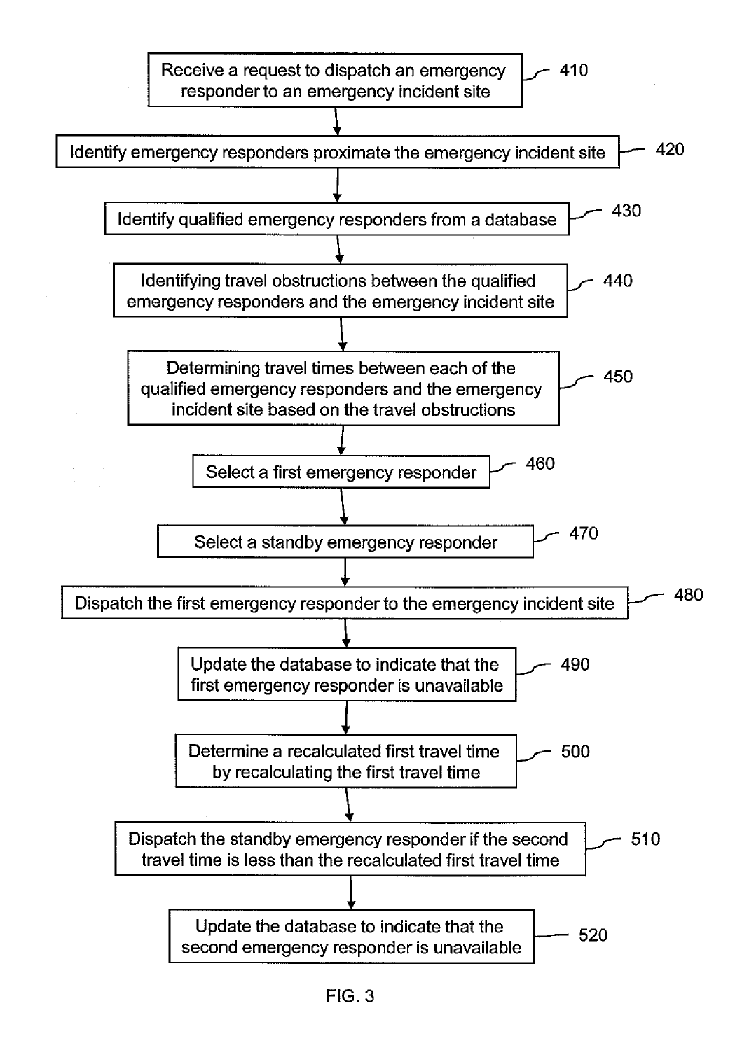

FIG. 3 is a flow diagram illustrating a method for dispatching at least one emergency responder to an emergency incident site according to another embodiment of the invention. The method receives a request to dispatch an emergency responder to an emergency incident site (410) and identifies emergency responders proximate the emergency incident site (420). As described above, the Emergency Call Center agent documents the data related to the request into the tool. The data includes the type of incident (e.g., fire, burglary, medical), the location of the incident, and the emergency response requirements needed for the request.

Of these emergency responders, qualified emergency responders are identified from a database, wherein qualified emergency responders have sufficient resources to service an emergency incident at the emergency incident site (430). As described above, each emergency response center has access to a centralized database where the availability of personnel and equipment are available. Updates are made due to schedules, equipment repairs, and additional capacity (e.g., new equipment).

The method identifies travel obstructions (e.g., traffic congestion due to road construction, traffic accidents, rush hour, and/or sporting events) that would impact travel between the qualified emergency responders and the emergency incident site (440). Travel times between each of the qualified emergency responders and the emergency incident site are determined based on the travel obstructions (450). As discussed above, information regarding route obstructions is obtained, for example, via transportation websites, radio traffic reports, social networks, government traffic cameras and/or speed detectors. In at least one embodiment, information regarding route obstructions is obtained using GPS data and/or congestion data from cellular telephone towers. This data includes information regarding the volume of GPS/cell phone users along a given route and their speed of travel along the route.

Based on the determined travel times, a first emergency responder is selected from the qualified emergency responders (460). The first emergency responder has a first travel time that is the shortest travel time of the determined travel times. One or more standby emergency responders are also selected from the qualified emergency responders based on the determined travel times (470). The standby emergency responders have a second travel time that is the next shortest travel time of the determined travel times.

The first emergency responder is dispatched to the emergency incident site (480); and, the database is updated to indicate that the first emergency responder is unavailable (490). If a delay is encountered by the first emergency responder (e.g., road construction), a recalculated first travel time is determined by recalculating the first travel time (500). The standby emergency responder is dispatched if the second travel time is less than the recalculated first travel time (510); and, the database is updated to indicate that the second emergency responder is unavailable (520). When the emergency incident has been resolved, the database is updated to indicate that the dispatched emergency responder(s) are now available.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computerusable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

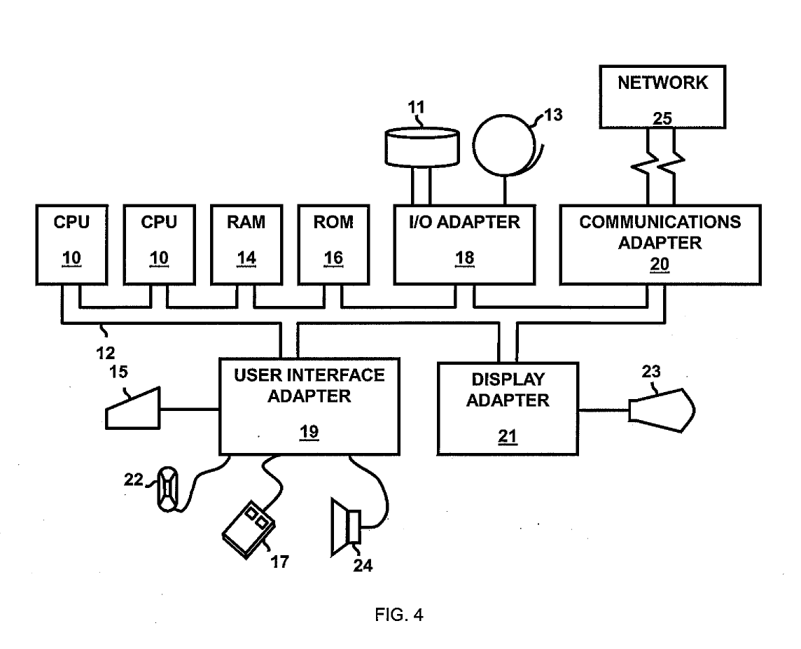

Referring now to FIG. 4, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for dispatching an emergency responder to an emergency incident site, said method including:
receiving a request to dispatch at least one emergency responder to an emergency incident site;
identifying emergency responders proximate said emergency incident site;
identifying qualified emergency responders of said emergency responders from a database, said qualified emergency responders having sufficient resources to service an emergency incident at said emergency incident site;
identifying travel obstructions between said qualified emergency responders and said emergency incident site, said travel obstructions including at least one of traffic congestion, road construction, and traffic accidents;
determining travel times between each of said qualified emergency responders and said emergency incident site based on said travel obstructions;
selecting, based on said determining of said travel times, a first emergency responder of said qualified emergency responders having a first travel time, said first travel time being the shortest travel time of said travel times;
selecting, based on said determining of said travel times, at least one standby emergency responder of said qualified emergency responders having a second travel time, said second travel time being the next shortest travel time of said travel times;
dispatching said first emergency responder to said emergency incident site;
updating said database to indicate that said first emergency responder is unavailable;
in response to said first emergency responder encountering a delay, determining a recalculated first travel time by recalculating said first travel time;
dispatching said standby emergency responder if said second travel time is less than said recalculated first travel time; and
updating said database to indicate that said second emergency responder is unavailable.
